(19) United States
(12) Patent Application Publication
(10) Pub. No.: US 2022/0056193 A1
(43) Pub. Date: Feb. 24, 2022

(54) ORGANOSILICON-MODIFIED POLYURETHANE RESIN AND METHOD FOR PRODUCING THE SAME

(71) Applicant: NAN YA PLASTICS CORPORATION, Taipei (TW)

(72) Inventors: TE-CHAO LIAO, TAIPEI (TW); SEN-HUANG HSU, TAIPEI (TW); CHIA-LUNG TSAI, TAIPEI (TW)

(21) Appl. No.: 17/337,618

(22) Filed: Jun. 3, 2021

(30) Foreign Application Priority Data
Aug. 24, 2020 (TW) 109128740

(51) Int. Cl. C08G 18/61; C08G 18/75; C08G 18/50; C08G 18/48; C08J 3/05

(52) U.S. Cl. CPC C08G 18/61; C08G 18/757; C08G 18/5096; C08J 2375/08; C08G 18/4825; C08J 3/05; C08G 18/4833

(57) ABSTRACT

An organosilicon-modified polyurethane resin and a method for producing the same are provided. The organosilicon-modified polyurethane resin includes organosilicon ingredients obtained by chemically bonding a first organosilicon chain extender having a chemical structure of formula (I) and a second organosilicon chain extender having a chemical structure of formula (II) into a molecular structure of a polyurethane resin during a polymerization reaction:

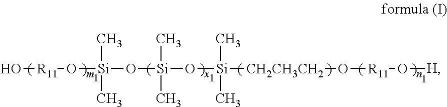

in which R₁₁ is a substituent of —CH₂CH₂— or —CH₂CH(CH₃)—, n₁ is a positive integer between 0 and 50, m₁ is a positive integer between 0 and 50, and x₁ is a positive integer between 4 and 100;

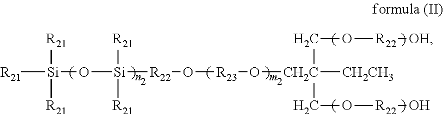

in which R₂₁ is a substituent of —CH₃ or —CH₂CH₃, R₂₂ is a substituent of —CH₂CH₂CH₂—, and R₂₃ is a substituent of —CH₂CH₂— or —CH₂CH(CH₃)—, n₂ is a positive integer between 6 and 130, and m₂ is a positive integer between 4 and 50.

### CROSS-REFERENCE TO RELATED PATENT APPLICATION

This application claims the benefit of priority to Taiwan Patent Application No. 109128740, filed on Aug. 24, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyurethane resin and a method for producing the same, and more particularly to an organosilicon-modified polyurethane resin and a method for producing the same.

### BACKGROUND OF THE DISCLOSURE

Polyurethane resin has a wide range of applications, such as synthetic leather fabrics or surface treatment agents. When the polyurethane resin is used in synthetic leather fabrics or surface treatment agents (e.g., PVC rubber, PU synthetic leather), silicone additives are usually added to the polyurethane resin to improve tactile feel of the synthetic leather and to improve anti-sticking, water resistance, and abrasion resistance properties of the synthetic leather fabrics.

In the related art, an organosilicon additive is generally added into a polyurethane resin by physical mixing. However, since an organosilicon ingredient of the organosilicon additive has poor compatibility with the polyurethane resin, the organosilicon ingredient may easily precipitate from a material surface of the polyurethane resin when the organosilicon additive is added into the polyurethane resin by physical mixing.

For example, in a case where the polyurethane resin is applied to synthetic leather fabrics or surface treatment agents, adding the silicone additives by physical mixing is likely to result in oil leakage from the material surface of the synthetic leather (due to the organosilicon ingredient precipitating from the material surface of the polyurethane resin). In addition, under mechanical action or long-term washing, performance of the material surface of the synthetic leather is also easily damaged.

### SUMMARY OF THE DISCLOSURE

In response to the above-referenced technical inadequacies, the present disclosure provides an organosilicon-modified polyurethane resin and a method for producing the same.

In one aspect, the present disclosure provides an organosilicon-modified polyurethane resin. The organosilicon-modified polyurethane resin includes organosilicon ingredients obtained by chemically bonding a first organosilicon chain extender having a chemical structure of formula (I) and a second organosilicon chain extender having a chemical structure of formula (II) into a molecular structure of a polyurethane resin during a polymerization reaction:

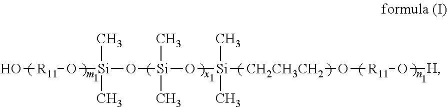

in which R₁₁ is a substituent of —CH₂CH₂— or —CH₂CH(CH₃)—, n₁ is a positive integer between 0 and 50, m₁ is a positive integer between 0 and 50, and x₁ is a positive integer between 4 and 100;

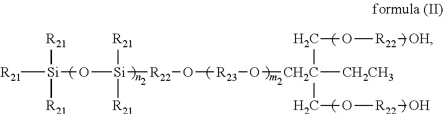

in which R₂₁ is a substituent of —CH₃ or —CH₂CH₃, R₂₂ is a substituent of —CH₂CH₂CH₂—, and R₂₃ is a substituent of —CH₂CH₂— or —CH₂CH(CH₃)—, n₂ is a positive integer between 6 and 130, and m₂ is a positive integer between 4 and 50.

In certain embodiments, the first organosilicon chain extender having the chemical structure of formula (I) is a polyether-siloxane copolymer with two hydroxyl groups (—OH) respectively at two ends thereof. The two hydroxyl groups at the two ends of the first organosilicon chain extender respectively react with two isocyanate groups (—NCO) during the polymerization reaction to enable the first organosilicon chain extender to chemically bond to the molecular structure of the polyurethane resin, so that the organosilicon ingredient of the first organosilicon chain extender is located in a main chain of the molecular structure of the polyurethane resin.

In certain embodiments, a polyether segment of the first organosilicon chain extender is at least one of polyoxyethylene and polyoxypropylene, in which a weight average molecular weight of the first organosilicon chain extender is between 500 and 6,000.

In certain embodiments, the second organosilicon chain extender having the chemical structure of formula (II) is an organosilicon compound with two hydroxyl groups (—OH) at one end thereof and no active hydrogen group at another end thereof. The two hydroxyl groups at the one end of the second organosilicon chain extender respectively react with two isocyanate groups (—NCO) during the polymerization reaction to enable the second organosilicon chain extender to chemically bond to the molecular structure of the polyurethane resin, so that the organosilicon ingredient of the second organosilicon chain extender extends outward from the molecular structure of the polyurethane resin in a form of a side chain.

In certain embodiments, the end of the second organosilicon chain extender that does not includes any active hydrogen group does not react with the isocyanate groups (—NCO) during the polymerization reaction.

In certain embodiments, a weight average molecular weight of the second organosilicon chain extender is between 500 and 6,000.

In certain embodiments, a solid content of silicon elements and oxygen elements in the molecular structure of the organosilicon-modified polyurethane resin is between 2% and 40%.

In certain embodiments, the molecular structure of the organosilicon-modified polyurethane resin has a main chain and a plurality of side chains respectively extending from the main chain. The solid content of the silicon elements and the oxygen elements of the main chain in the molecular structure of the organosilicon-modified polyurethane resin is between 2% and 20%, and the solid content of the silicon elements and the oxygen elements of the side chains in the molecular structure of the organosilicon-modified polyurethane resin is between 2% and 20%.

In another aspect, the present disclosure provides a method for producing an organosilicon-modified polyurethane resin, which includes: adding a polyol, a first organosilicon chain extender, and a second organosilicon chain extender into a reactor to form a reaction mixture; and adding di-isocyanate into the reaction mixture to carry out a polymerization reaction, so as to form the organosilicon-modified polyurethane resin. The polymerization reaction enables hydroxyl groups (—OH) of each components in the reaction mixture to react with isocyanate groups (—NCO) of the di-isocyanate. The first organosilicon chain extender has a chemical structure of formula (I):

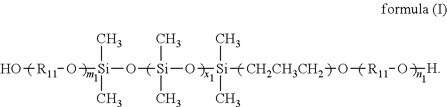

R₁₁ is a substituent of —CH₂CH₂— or —CH₂CH(CH₃)—, n₁ is a positive integer between 0 and 50, m₁ is a positive integer between 0 and 50, and x₁ is a positive integer between 4 and 100.

The second organosilicon chain extender has a chemical structure of formula (II):

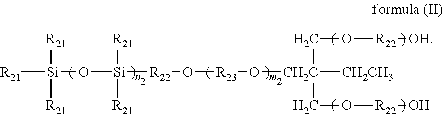

R₂₁ is a substituent of —CH₃ or —CH₂CH₃, R₂₂ is a substituent of —CH₂CH₂CH₂—, and R₂₃ is a substituent of —CH₂CH₂— or —CH₂CH(CH₃)—, n₂ is a positive integer between 6 and 130, and m₂ is a positive integer between 4 and 50.

In certain embodiments, the first organosilicon chain extender having the chemical structure of formula (I) is a polyether-siloxane copolymer with two hydroxyl groups (—OH) respectively at two ends thereof. The two hydroxyl groups at the two ends of the first organosilicon chain extender respectively react with two isocyanate groups (—NCO) of the di-isocyanate during the polymerization reaction to enable the first organosilicon chain extender to chemically bond to the molecular structure of the polyurethane resin, so that an organosilicon ingredient of the first organosilicon chain extender is located in a main chain of the molecular structure of the polyurethane resin.

In certain embodiments, the second organosilicon chain extender having the chemical structure of formula (II) is an organosilicon compound with two hydroxyl groups (—OH) at one end thereof and no active hydrogen group at another end thereof. The two hydroxyl groups at the one end of the second organosilicon chain extender respectively react with two isocyanate groups (—NCO) of the di-isocyanate during the polymerization reaction to enable the second organosilicon chain extender to chemically bond to the molecular structure of the polyurethane resin, so that an organosilicon ingredient of the second organosilicon chain extender extends outward from the molecular structure of the polyurethane resin in a form of a side chain.

In yet another aspect, the present disclosure provides an organosilicon-modified polyurethane resin. The organosilicon-modified polyurethane resin includes organosilicon ingredients obtained by chemically bonding a first organosilicon chain extender and a second organosilicon chain extender into a molecular structure of a polyurethane resin during a polymerization reaction. The first organosilicon chain extender is a polyether-siloxane copolymer with two hydroxyl groups (—OH) respectively at two ends thereof. The two hydroxyl groups at the two ends of the first organosilicon chain extender respectively react with two isocyanate groups (—NCO) during the polymerization reaction to enable the first organosilicon chain extender to chemically bond to the molecular structure of the polyurethane resin, so that the organosilicon ingredient of the first organosilicon chain extender is located in a main chain of the molecular structure of the polyurethane resin. The second organosilicon chain extender is an organosilicon compound with two hydroxyl groups (—OH) at one end thereof and no active hydrogen group at another end thereof. The two hydroxyl groups at the one end of the second organosilicon chain extender respectively react with another two isocyanate groups (—NCO) during the polymerization reaction to enable the second organosilicon chain extender to chemically bond to the molecular structure of the polyurethane resin, so that the organosilicon ingredient of the second organosilicon chain extender extends outward from the molecular structure of the polyurethane resin in a form of a side chain.

Therefore, in the organosilicon-modified polyurethane resin and the method for producing the same provided by the present disclosure, by virtue of “the organosilicon-modified polyurethane resin including organosilicon ingredients obtained by chemically bonding a first organosilicon chain extender having a chemical structure of formula (I) and a second organosilicon chain extender having a chemical structure of formula (II) into a molecular structure of a polyurethane resin during a polymerization reaction”, the organosilicon-modified polyurethane resin can provide excellent anti-sticking, water resistance, abrasion resistance, and alcohol friction resistance properties, and excellent leather tactile feel when being applied to a surface of a synthetic leather.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Organosilicon-Modified Polyurethane Resin

In the related art, an organosilicon additive is generally added into a polyurethane resin by physical mixing. However, since an organosilicon ingredient of the organosilicon additive has poor compatibility with the polyurethane resin, the organosilicon ingredient may easily precipitate from a material surface of the polyurethane resin when the organosilicon additive is added into the polyurethane resin by physical mixing, thereby causing many issues associated with material application.

To improve the technical issues mentioned above, an embodiment of the present disclosure provides an organosilicon-modified polyurethane resin. The organosilicon-modified polyurethane resin is formed by chemically bonding organosilicon ingredients to a main chain and side chains of a molecular structure of a polyurethane resin, so that the organosilicon ingredients can be retained in the polyurethane resin for a long time. As a result, the organosilicon-modified polyurethane resin can provide excellent material surface properties, such as anti-sticking, water resistance, abrasion resistance, and alcohol friction resistance properties. Moreover, the above-mentioned problem of the organosilicon ingredient precipitating from the material surface can be effectively resolved.

To achieve the above objective, the organosilicon-modified polyurethane resin includes organosilicon ingredients, which are obtained by chemically bonding a first organosilicon chain extender having a chemical structure of formula (I) and a second organosilicon chain extender having a chemical structure of formula (II) into the molecular structure of the polyurethane resin during a polymerization reaction.

The first organosilicon chain extender having the chemical structure of formula (I) is represented as follows:

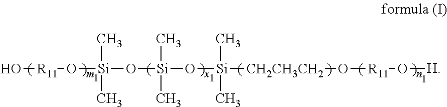

R₁₁ is a substituent of —CH₂CH₂— or —CH₂CH(CH₃)—.

n₁ is a positive integer between 0 and 50, and preferably between 0 and 20. m₁ is a positive integer between 0 and 50, and preferably between 0 and 20. Furthermore, x₁ is a positive integer between 4 and 100, and preferably between 10 and 40.

More specifically, the first organosilicon chain extender represented by the formula (I) is a polyether-siloxane copolymer with two hydroxyl groups (—OH) respectively at two ends of a linear molecular structure of the first organosilicon chain extender. In addition, a middle portion of the linear molecular structure of the first organosilicon chain extender has repeating structural units of siloxane (—(R)₂Si—O—). That is, the repeating structural units of siloxane are located between the two hydroxyl groups of the linear molecular structure of the first organosilicon chain extender.

The two hydroxyl groups at the two ends of the first organosilicon chain extender respectively react with two isocyanate groups (—NCO) of a di-isocyanate during the polymerization reaction to enable the first organosilicon chain extender to chemically bond to the molecular structure of the polyurethane resin.

In the above-mentioned polymerization reaction, the organo silicon ingredient of the first organosilicon chain extender is located in a main chain of the molecular structure of the polyurethane resin after the chemical bonding between the hydroxyl groups and the isocyanate groups is reacted. That is, the first organosilicon chain extender with the two hydroxyl groups respectively at the two ends thereof can provide an organo silicon structure (i.e., the repeating structural units of siloxane) in the main chain of the polyurethane resin, thereby improving mechanical strength, softness, and tactile feel of a synthetic leather treated by the organosilicon-modified polyurethane resin.

Furthermore, in the first organosilicon chain extender, a polyether segment of the polyether-siloxane copolymer is at least one of polyoxyethylene and polyoxypropylene.

In addition, a weight average molecular weight of the first organo silicon chain extender is between 500 and 6,000, preferably between 1,000 and 4,000, and more preferably between 2,000 and 3,000, but the present disclosure is not limited thereto. The weight average molecular weight and a chain length of the first organosilicon chain extender are mainly determined by the numerical range of n1, m1, and x1.

Accordingly, the first organosilicon chain extender enables a resin material to provide sufficient mechanical strength, softness, and tactile feel when being applied to synthetic leather materials.

If the molecular weight exceeds the above range, the resin material may become unsatisfactory with respect to mechanical strength, softness, and tactile feel.

The second organosilicon chain extender having the chemical structure of formula (II) is represented as follows:

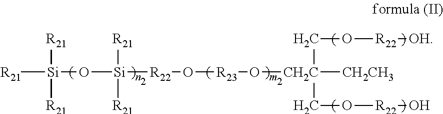

R₂₁ is a substituent of —CH₃ or —CH₂CH₃, R₂₂ is a substituent of —CH₂CH₂CH₂—, and R₂₃ is a substituent of —CH₂CH₂— or —CH₂CH(CH₃)—.

n₂ is a positive integer between 6 and 130, and preferably between 10 and 100. Furthermore, m₂ is a positive integer between 4 and 50, and preferably between 10 and 40.

More specifically, the second organosilicon chain extender represented by the formula (II) is an organosilicon compound that has two hydroxyl groups (—OH) at one end of a linear molecular structure thereof, and no active hydrogen group at another end of the linear molecular structure thereof.

In addition, the one end of the linear molecular structure where the two hydroxyl groups (—OH) are located is roughly E-shaped, and the two hydroxyl groups are located on tail ends of upper and lower sides of the E-shaped structure, respectively. The linear molecular structure of the second organosilicon chain extender has repeating structural units of siloxane (—(R)₂Si—O—). The repeating structural units of siloxane are located at a side of the E-shaped structure of the linear molecular structure and extend in a long chain shape.

Furthermore, the two hydroxyl groups (—OH) at the one end of the second organosilicon chain extender respectively react with two isocyanate groups (—NCO) of a di-isocyanate during the polymerization reaction to enable the second organosilicon chain extender to chemically bond to the molecular structure of the polyurethane resin.

In the above-mentioned polymerization reaction, the organo silicon ingredient of the second organosilicon chain extender extends outward from the molecular structure of the polyurethane resin in a form of a side chain. In addition, the organosilicon ingredient of the second organosilicon chain extender is not located in the main chain of the molecular structure of the polyurethane resin.

That is, the organosilicon compound with the two hydroxyl groups at the one end thereof and no active hydrogen group at the another end thereof can provide an organo silicon structure to a plurality of side chains of the polyurethane resin, so that the synthetic leather treated by the organosilicon-modified polyurethane resin can have good tactile feel, and good anti-sticking, water resistance, abrasion resistance, and alcohol friction resistance properties.

It is worth mentioning that the end of the second organosilicon chain extender that does not includes any active hydrogen group does not react with the isocyanate group (—NCO) during the polymerization reaction.

Furthermore, the weight average molecular weight of the second organosilicon chain extender is between 500 and 6,000, preferably between 1,000 and 4,000, and more preferably between 2,000 and 3,000, but the present disclosure is not limited thereto. The weight average molecular weight and the chain length of the second organosilicon chain extender are mainly determined by the numerical range of n₂ and m₂.

Accordingly, the second organosilicon chain extender enables the resin material to provide sufficient anti-sticking, water resistance, abrasion resistance, and alcohol friction resistance properties when being applied to synthetic leather materials.

If the molecular weight exceeds the above range, the resin material may become unsatisfactory with respect to tactile feel, and anti-sticking, water resistance, abrasion resistance, or alcohol friction resistance properties.

Furthermore, a solid content of silicon elements and oxygen elements in the molecular structure of the organosilicon-modified polyurethane resin is between 2% and 40%, preferably between 2% and 25%, and more preferably between 3% and 10%, but the present disclosure is not limited thereto.

The source of the above-mentioned silicon elements and oxygen elements is mainly the repeating structural units of siloxane. Furthermore, it should be noted that the unit “%” of the solid content used in this article refers to a percentage by weight, such as “% (w/w)” or “wt %”.

More specifically, the molecular structure of the organosilicon-modified polyurethane resin has at least a main chain and a plurality of side chains respectively extending from the main chain.

The solid content of the silicon elements and the oxygen elements of the main chain in the molecular structure of the organosilicon-modified polyurethane resin is between 2% and 20%, preferably between 2% and 15%, and more preferably between 3% and 10%. In addition, the solid content of the silicon elements and the oxygen elements of the side chains in the molecular structure of the organosilicon-modified polyurethane resin is between 2% and 20%, preferably between 2% and 15%, and more preferably between 3% and 10%, but the present is not limited thereto.

If the solid content of the silicon elements and the oxygen elements of the main chain in the entire molecular structure is within the above range (i.e., between 2% and 20%), the resin material enables the synthetic leather to have sufficient mechanical strength, softness, and tactile feel. If the solid content exceeds the above range, the resin material may become unsatisfactory with respect to mechanical strength, softness, or tactile feel.

If the solid content of the silicon elements and the oxygen elements of the side chains in the entire molecular structure is within the above range (i.e., between 2% and 20%), the resin material enables the synthetic leather to have sufficient anti-sticking, water resistance, abrasion resistance, and alcohol friction resistance properties. If the solid content exceeds the above range, the anti-sticking, water resistance, abrasion resistance, or alcohol friction resistance properties of the resin material may become unsatisfactory.

### Method for Producing Organosilicon-Modified Polyurethane Resin

The above contents are the relevant descriptions of the material characteristics of the organosilicon-modified polyurethane resin of the present embodiment, and a method for producing the organosilicon-modified polyurethane resin will be described below according to the embodiment of the present disclosure.

The method for producing the organosilicon-modified polyurethane resin includes steps of S110 to S140. It should be noted that a sequence of the steps and an actual manner of operation described in the present embodiment can be adjusted according to requirements and are not limited to those described in the present embodiment.

The step S110 includes sequentially adding a diol and/or polyol reactant, the first organosilicon chain extender having the chemical structure of formula (I), the second organosilicon chain extender having the chemical structure of formula (II), and dimethylolpropionic acid (DMPA) into a reactor to form a reaction mixture.

The step S120 includes uniformly stirring the reaction mixture and heating the reaction mixture to a preheating temperature. The preheating temperature is preferably between 70° C. and 90° C., and more preferably between 75° C. and 85° C., but the present disclosure is not limited thereto.

The step S130 includes adding di-isocyanate to the reaction mixture and heating the reaction mixture to a reaction temperature to perform a polymerization reaction. The polymerization reaction enables the hydroxyl groups (—OH) of the components in the reaction mixture to react with the isocyanate groups (—NCO) of the di-isocyanate. Furthermore, the reaction temperature of the polymerization reaction is preferably between 85° C. and 95° C., and more preferably between 85° C. and 90° C. A reaction time of the polymerization reaction is preferably between 2 hours and 5 hours, and more preferably between 2 hours and 3 hours, but the present disclosure is not limited thereto.

The step S140 includes cooling the reaction mixture to about 30° C. to 50° C.; adding triethylamine (TEA) into the reaction mixture and continuing the reaction for about 15 minutes to 30 minutes; cooling the reaction mixture to a room temperature; adding 200 grams to 220 grams of deionized water to the reaction mixture at 500 rpm; adding 2 grams to 5 grams of ethylenediamine to the reaction mixture to carry out a chain extension reaction for about 20 minutes to 40 minutes; and finally obtaining the organosilicon-modified polyurethane resin (especially a carboxylate type waterborne polyurethane resin emulsion).

### Experimental Data and Results

Hereinafter, the contents of the present disclosure will be described in detail with reference to Exemplary Example 1 and Comparative Example 1. However, the following examples are only to help understand the present disclosure, and the scope of the present disclosure is not limited to these examples.

Exemplary Example 1 is prepared by: sequentially adding 33 grams of PTMG2000 (polyether glycol), 21 grams of polyether-siloxane copolymer with two hydroxyl groups respectively at two ends thereof (the first organosilicon chain extender), 21 grams of organosilicon with two hydroxyl groups at one end thereof and no active hydrogen group at another end thereof (the second organosilicon chain extender), and 3.2 grams of dimethylolpropionic acid (DMPA) chain extender into a reactor to form a reaction mixture; stirring the reaction mixture at a constant speed and heating the reaction mixture to 80° C.; adding 24.6 grams of isophorone diisocyanate into the reaction mixture and heating the reaction mixture to 85° C. to 90° C. to perform a polymerization reaction; carrying out the polymerization reaction for 2 hours to 3 hours at the reaction temperature and then cooling the reaction mixture to 30° C. to 50° C.; adding 2.6 grams of triethylamine (TEA) to continue the polymerization reaction for 15 to 30 minutes and then cooling the reaction mixture to a room temperature; adding 210 grams of deionized water to the reaction mixture at 500 rpm; adding 3 grams of ethylenediamine to the reaction mixture to carry out a chain extension reaction for about 30 minutes; and finally obtaining an organosilicon-modified polyurethane resin (especially a carboxylate type waterborne polyurethane resin emulsion).

Comparative Example 1 is prepared by: sequentially adding 75 grams of PTMG2000 (polyether glycol) and 3.2 grams of dimethylolpropionic acid (DMPA) chain extender into a reactor to form a reaction mixture; stirring the reaction mixture at a constant speed and heating the reaction mixture to 80° C.; adding 24.6 grams of isophorone diisocyanate into the reaction mixture and heating the reaction mixture to 85° C. to 90° C. to perform a polymerization reaction; carrying out the polymerization reaction for 2 hours to 3 hours at the reaction temperature and then cooling the reaction mixture to 30° C. to 50° C.; adding 2.6 grams of triethylamine (TEA) to continue the polymerization reaction for 15 to 30 minutes and then cooling the reaction mixture to a room temperature; adding 210 grams of deionized water to the reaction mixture at 500 rpm; adding 3 grams of ethylenediamine to the reaction mixture to carry out a chain extension reaction for about 30 minutes; and finally obtaining a carboxylate type waterborne polyurethane resin emulsion (unmodified polyurethane resin).

Next, the organosilicon modified polyurethane resin prepared in Exemplary Example 1 and the unmodified polyurethane resin prepared in Comparative Example 1 are applied to fabrics of synthetic leathers, and surfaces of the synthetic leathers are subjected to physical and chemical property tests regarding anti-sticking, water resistance, abrasion resistance, and alcohol friction resistance properties, and leather tactile feel, etc. The related test methods are described as follows, and the related test results are summarized in Table 1.

The anti-sticking property is tested by: coating a polyurethane resin on a surface of the synthetic leather and baking the polyurethane resin at 130° C. for 2 minutes; stacking two synthetic leather test pieces face to face with each other; sandwiching the two synthetic leather test pieces between two pieces of glass; pressing them with a weight of 3 kg on a surface of one of the two pieces of glass; placing the synthetic leather test pieces and the two pieces of glass in an oven at 85±2° C. for 24 hours; taking out the synthetic leather test pieces and the two pieces of glass; removing the weight and cooling the synthetic leather test pieces for 1 hour; and gently peeling off the two synthetic leather test pieces stacked on each other by hand and then evaluating the anti-sticking property. A five-grade evaluation of anti-sticking property is described as follows. Grade 5 means that the test pieces can be gently peeled off from each other. Grade 4 means that the test pieces can be peeled off from each other by applying a weak force. Grade 3 means that the test pieces can only be peeled off from each other by applying a medium force, after which the surfaces of the test pieces are not damaged. Grade 2 means that the test pieces can only be peeled off from each other by applying a strong force, after which the surfaces of the test pieces are not completely damaged. Grade 1 means that the test pieces cannot be peeled off from each other.

The water resistance property is tested by: coating a polyurethane resin on a Teflon board to form a film with a thickness of about 1 mm; and completely drying and placing the film in deionized water at 25° C. for 24 hours, and then observing weight changes of the film before and after soaking.

The abrasion resistance property is tested by: coating a polyurethane resin on a surface of a synthetic leather and baking the polyurethane resin at 130° C. for 2 minutes; cutting the synthetic leather to an appropriate size as a test piece; and then placing the test piece on a TABER friction tester and using a H-22 grinding wheel to test the number of worn circles of the test piece.

The alcohol friction resistance property is tested by: coating a polyurethane resin on a surface of a synthetic leather and baking the polyurethane resin at 130° C. for 2 minutes; cutting the synthetic leather to an appropriate size as a test piece; placing the test piece on a friction test machine to test for colorfastness to crocking; putting a standard white cotton cloth on the machine and rubbing the test piece back and forth for 10 times after soaking the standard white cotton cloth in 95% alcohol; removing the standard white cotton cloth; and then evaluating the amount of color transferred to the standard white cotton cloth. The grading standard is compared with the standard sample card and can be divided into 5 grades, with grade 1 being the worst (severe color transfer), and grade 5 being the best (no color transfer at all).

TABLE 1
Related Test Results

| | Exemplary Example 1 | Comparative Example 1 |
|---|---|---|
| | organosilicon-modified | unmodified |
| | polyurethane resin | polyurethane resin |
| anti-sticking | grade 5 | grade 3 |
| property | | |
| water resistance | 1.5% weight change | 3% weight change |
| property | | |
| abrasion resistance | 900 circles | 300 circles |
| property | | |
| alcohol friction | grade 3 to grade 4 | grade 1 to grade 2 |
| resistance property | | |
| leather tactile feel | smooth | less smooth |

According to the test results shown in Table 1, when the polyurethane resin prepared in Exemplary Example 1 is applied to the surface of the synthetic leather, excellent leather tactile feel and anti-sticking, water resistance, abrasion resistance, and alcohol friction resistance properties are exhibited. The test results show that the performances of Exemplary Example 1 are better than those of Comparative Example 1.

### Beneficial Effects of the Embodiment

In conclusion, by virtue of “the organosilicon-modified polyurethane resin includes organosilicon ingredient, which are obtained by chemically bonding a first organosilicon chain extender having a chemical structure of formula (I) and a second organosilicon chain extender having a chemical structure of formula (II) into a molecular structure of a polyurethane resin during a polymerization reaction”, the organosilicon-modified polyurethane resin can exhibit excellent properties of anti-sticking, water resistance, abrasion resistance, alcohol friction resistance, and leather tactile feel when being applied to a surface of a synthetic leather.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An organosilicon-modified polyurethane resin, comprising organosilicon ingredients obtained by chemically bonding a first organosilicon chain extender having a chemical structure of formula (I) and a second organosilicon chain extender having a chemical structure of formula (II) into a molecular structure of a polyurethane resin during a polymerization reaction: 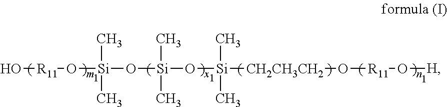
wherein R₁₁ is a substituent of —CH₂CH₂— or —CH₂CH(CH₃)—, n₁ is a positive integer between 0 and 50, m₁ is a positive integer between 0 and 50, and x₁ is a positive integer between 4 and 100; 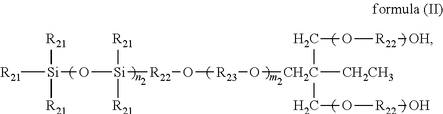
wherein R₂₁ is a substituent of —CH₃ or —CH₂CH₃, R₂₂ is a substituent of —CH₂CH₂CH₂—, and R₂₃ is a substituent of —CH₂CH₂— or —CH₂CH(CH₃)—, n₂ is a positive integer between 6 and 130, and m₂ is a positive integer between 4 and 50.

2. The organosilicon-modified polyurethane resin according to claim 1, wherein the first organosilicon chain extender having the chemical structure of formula (I) is a polyether-siloxane copolymer with two hydroxyl groups (—OH) respectively at two ends thereof; wherein the two hydroxyl groups at the two ends of the first organosilicon chain extender respectively react with two isocyanate groups (—NCO) during the polymerization reaction to enable the first organosilicon chain extender to chemically bond to the molecular structure of the polyurethane resin, so that the organosilicon ingredient of the first organosilicon chain extender is located in a main chain of the molecular structure of the polyurethane resin.

3. The organosilicon-modified polyurethane resin according to claim 2, wherein a polyether segment of the first organosilicon chain extender is at least one of polyoxyethylene and polyoxypropylene; wherein a weight average molecular weight of the first organosilicon chain extender is between 500 and 6,000.

4. The organosilicon-modified polyurethane resin according to claim 1, wherein the second organosilicon chain extender having the chemical structure of formula (II) is an organosilicon compound with two hydroxyl groups (—OH) at one end thereof and no active hydrogen group at another end thereof; wherein the two hydroxyl groups at the one end of the second organosilicon chain extender respectively react with two isocyanate groups (—NCO) during the polymerization reaction to enable the second organosilicon chain extender to chemically bond to the molecular structure of the polyurethane resin, so that the organosilicon ingredient of the second organosilicon chain extender extends outward from the molecular structure of the polyurethane resin in a form of a side chain.

5. The organosilicon-modified polyurethane resin according to claim 4, wherein the another end of the second organosilicon chain extender that includes no active hydrogen group does not react with the isocyanate groups (—NCO) during the polymerization reaction.

6. The organosilicon-modified polyurethane resin according to claim 4, wherein a weight average molecular weight of the second organosilicon chain extender is between 500 and 6,000.

7. The organosilicon-modified polyurethane resin according to claim 1, wherein a solid content of silicon elements and oxygen elements in the molecular structure of the organosilicon-modified polyurethane resin is between 2% and 40%.

8. The organosilicon-modified polyurethane resin according to claim 7, wherein the molecular structure of the organosilicon-modified polyurethane resin has a main chain and a plurality of side chains respectively extending from the main chain; wherein the solid content of the silicon elements and the oxygen elements of the main chain in the molecular structure of the organosilicon-modified polyurethane resin is between 2% and 20%, and the solid content of the silicon elements and the oxygen elements of the side chains in the molecular structure of the organosilicon-modified polyurethane resin is between 2% and 20%.

9. A method for producing an organosilicon-modified polyurethane resin, comprising:
adding a polyol, a first organosilicon chain extender, and a second organosilicon chain extender into a reactor to form a reaction mixture; and
adding di-isocyanate into the reaction mixture to carry out a polymerization reaction, so as to form the organosilicon-modified polyurethane resin; wherein the polymerization reaction enables hydroxyl groups (—OH) of each component in the reaction mixture to react with isocyanate groups (—NCO) of the di-isocyanate;
wherein the first organosilicon chain extender has a chemical structure of formula (I): 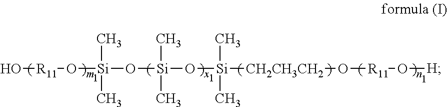
wherein R₁₁ is a substituent of —CH₂CH₂— or —CH₂CH(CH₃)—, n₁ is a positive integer between 0 and 50, m₁ is a positive integer between 0 and 50, and x₁ is a positive integer between 4 and 100;
wherein the second organosilicon chain extender has a chemical structure of formula (II): 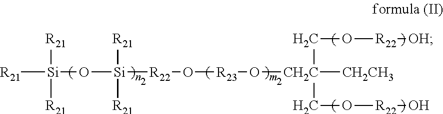
wherein R₂₁ is a substituent of —CH₃ or —CH₂CH₃, R₂₂ is a substituent of —CH₂CH₂CH₂—, and R₂₃ is a substituent of —CH₂CH₂— or —CH₂CH(CH₃)—, n₂ is a positive integer between 6 and 130, and m₂ is a positive integer between 4 and 50.

10. The method according to claim 9, wherein the first organosilicon chain extender having the chemical structure of formula (I) is a polyether-siloxane copolymer with two hydroxyl groups (—OH) respectively at two ends thereof; wherein the two hydroxyl groups at the two ends of the first organosilicon chain extender respectively react with two isocyanate groups (—NCO) of the di-isocyanate during the polymerization reaction to enable the first organosilicon chain extender to chemically bond to the molecular structure of the polyurethane resin, so that an organosilicon ingredient of the first organosilicon chain extender is located in a main chain of the molecular structure of the polyurethane resin.

11. The method according to claim 9, wherein the second organosilicon chain extender having the chemical structure of formula (II) is an organosilicon compound with two hydroxyl groups (—OH) at one end thereof and no active hydrogen group at another end thereof; wherein the two hydroxyl groups at the one end of the second organosilicon chain extender respectively react with two isocyanate groups (—NCO) of the di-isocyanate during the polymerization reaction to enable the second organosilicon chain extender to chemically bond to the molecular structure of the polyurethane resin, so that an organosilicon ingredient of the second organosilicon chain extender extends outward from the molecular structure of the polyurethane resin in a form of a side chain.

12. An organosilicon-modified polyurethane resin, comprising organosilicon ingredients obtained by chemically bonding a first organosilicon chain extender and a second organosilicon chain extender into a molecular structure of a polyurethane resin during a polymerization reaction;
wherein the first organosilicon chain extender is a polyether-siloxane copolymer with two hydroxyl groups (—OH) respectively at two ends thereof; wherein the two hydroxyl groups at the two ends of the first organosilicon chain extender respectively react with two isocyanate groups (—NCO) during the polymerization reaction to enable the first organosilicon chain extender to chemically bond to the molecular structure of the polyurethane resin, so that the organosilicon ingredient of the first organosilicon chain extender is located in a main chain of the molecular structure of the polyurethane resin;
wherein the second organosilicon chain extender is an organosilicon compound with two hydroxyl groups (—OH) at one end thereof and no active hydrogen group at another end thereof; wherein the two hydroxyl groups at the one end of the second organosilicon chain extender respectively react with another two isocyanate groups (—NCO) during the polymerization reaction to enable the second organo silicon chain extender to chemically bond to the molecular structure of the polyurethane resin, so that the organosilicon ingredient of the second organosilicon chain extender extends outward from the molecular structure of the polyurethane resin in a form of a side chain.
